(19) United States
(12) Patent Application Publication
(10) Pub. No.: US 2011/0298221 A1
(43) Pub. Date: Dec. 8, 2011

(54) Power Tiles

(76) Inventor: David Kaurin, Mansfield, TX (US)

(21) Appl. No.: 12/802,216

(22) Filed: Jun. 3, 2010

(51) Int. Cl. H02K 7/18

(52) U.S. Cl. 290/1 R

(57) ABSTRACT

Power Tiles are generators of electric energy that use energy of the bodies/objects such as trains, vehicles, airplanes, people, and animals which are already in motion. Power Tiles are installed as pavements or under pavements and/or under railroad tracks. Power Tiles generate electric energy when exposed to various force applied by people, animals, vehicles, airplanes, and/or trains that are running over it or are stepping on it. Power Tiles are capable of generating amounts of electrical power that can contribute to the existing power production and eventually replace some of the existing ways of generating power that cause high pollution or are too expensive. Power Tiles can be installed in the areas close to consumers, which means that these generators do not require transferring of electrical energy at long distances as the most of existing generators do, which lowers the overall cost of the power generated by Power Tiles.

### CROSS-REFERENCE TO RELATED APPLICATIONS

Not Applicable

### STATEMENT REGARDING FEDERALLY SPONSORED RESEARCH OR DEVELOPMENT

Not Applicable

### FIELD OF INVENTION

The invention lies in the field of generating and distributing of electrical power.

### REFERENCE TO SEQUENCE LISTING, A TABLE, OR A COMPUTER PROGRAM LISTING COMPACT DISC APPENDIX

Not Applicable

### BACKGROUND OF THE INVENTION

Power Tiles are intended to improve present situation in power-generating through the generating of electrical power that is effective, convenient, clean, affordable, and available wherever change in level of mechanical force exists. In addition, it can help improve life through its use in increasing awareness about healthy lifestyle, physical fitness, and health.

### BRIEF SUMMARY OF THE INVENTION

Power Tiles are electrical generators installed as pavement or under pavement on roads (streets, highways, or any other roads), walking surfaces, and/or on railroads (under, on, or along individual railroad tracks). They can also be installed on airport runways and sport fields. Its installation is not limited to the previously mentioned cases. The power is produced by force applied on generators by moving objects or bodies. Power generators are inexpensive and clean source of electrical power since they use gravity and energy of objects that are already in motion.

### BRIEF DESCRIPTION OF THE DRAWINGS

FIG. 1A (As Surface) is the way to install the Power Tiles as an actual pavement. The top of P-Tiles is made of material that is adequate for the particular place (such as hallways).

FIG. 1B (In Surface) is the way to install generators apart from each other.

FIG. 1C (Under Surface) is the way to install the generators under the surface in the case where such installation is desirable.

FIG. 2A (Under Railroad Tracks) is the way to install the Power Tiles under the railroad tracks. The generators may be located at different distances from each other or be next to each other.

FIG. 2B (On the Tie) is an installation in which generators are placed between ties and rails (under the rail and on the tie).

FIG. 2C (Alongside Tracks) is a way to install generators that will be in direct contact with the train wheels.

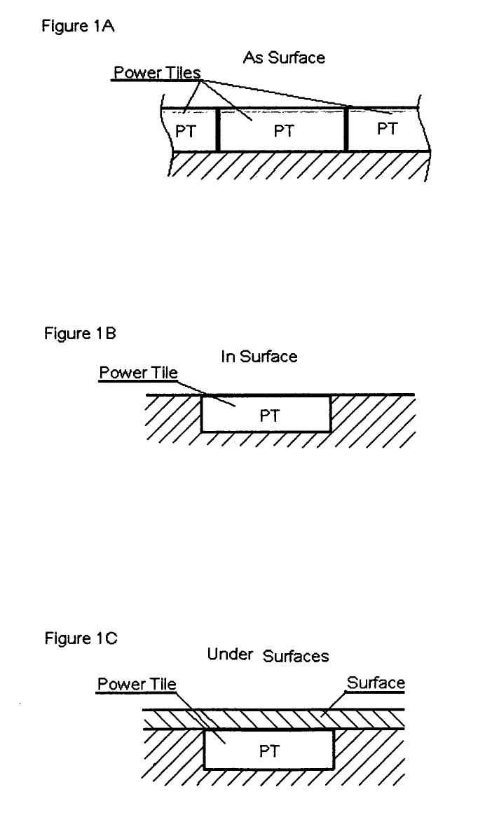

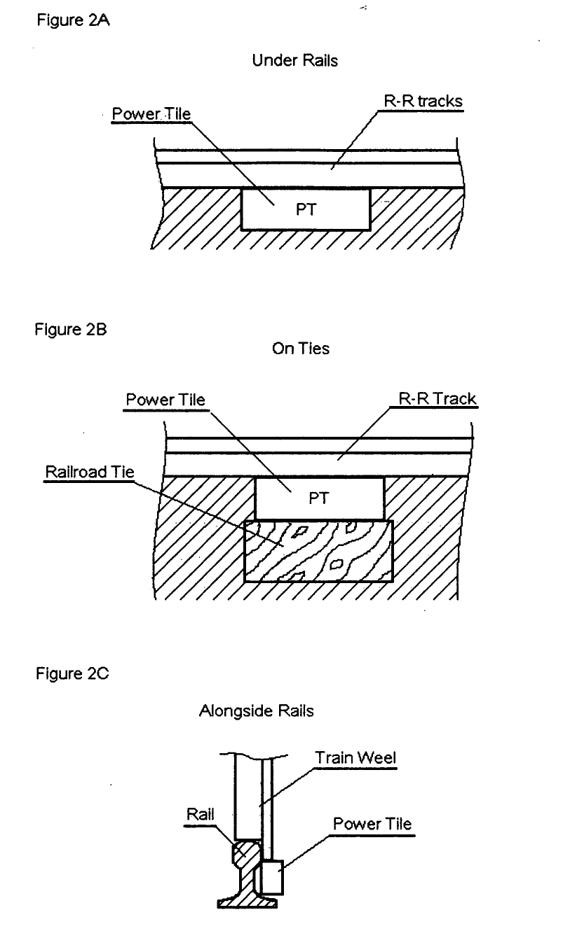

### DETAILED DESCRIPTION OF THE INVENTION

Power Tiles are electrical generators of various types and sizes that are installed in or as pavement, and on railroads. When installed Power Tiles will be primary or secondary source of electrical power depending on the place of its use and the size of the generators. The power is produced by force (weight) being applied on Power Tiles. The force comes from vehicles (trains, automobiles, or any other vehicles), or people running over Power Tiles or stepping on them. Power Tiles with higher power-producing capacity are installed on freeways, highways, streets (and any other roads) runways, and railroads; and are powered by vehicles, trains and airplanes. Power Tiles of smaller size and capacity installed in hallways and other high traffic areas (indoors and/or outdoors) are powered by pedestrians stepping on them while walking and/or running as well as while doing any other activity that involves applying various weight.

The generators that are used in Power Tiles can be of different types such as generators that generate electricity by wire (coil) being under influence of alternate magnetic field, generators based on piezoelectric effect, or any other generators that can be adapted for this purpose. Power Tiles are connected to the place where the electrical energy that has been produced may be stored and/or adapted for its particular use, or it may be used directly as produced.

This product can have various uses. Power Tiles may be used to generate big amount of energy that can be used as a main source of electrical power. It can also be used as an alternative source of energy in the case of power outage. Good examples for the later are outages on railroad crossings, and freeway exits and entrances caused by problems on the power lines supplying these places from remote sources. This use of generators is also useful in areas where bringing electrical power from a far away source is impractical and/or too expensive. Power Tiles can also be used for supplying lighting and signal-lighting on roads and railroads. In addition, Power Tiles can provide power for the charging stations used to charge electric vehicles or hybrids.

Furthermore, generators can provide energy for displays and ads that are showing facts such as how many watts of electricity has been generated and how many calories have been burned by people stepping on Power Tiles in that area which will, in this case, be an interactive tool used to improve health and quality of life while at the same time potentially generating more electrical power than it is needed to just power the displays. The use of Power Tiles is not by any meaning limited to those mentioned previously.

Power Tiles generate electric power with minimum pollution, if any. By use of Power Tiles, roads and railroads will become major producers of electrical power. Distribution of that power is inexpensive in comparison to the distribution systems that are in use now since electricity will be produced close to consumers and there will be no need for big, expensive distribution systems. Power Tiles will provide clean and inexpensive electrical power.

1. Power Tiles will generate electric energy by converting energy of bodies or objects (such as vehicles, trains, airplanes, people, and animals) in motion into electric energy.

2. Use of Power Tiles generates energy in the way that is more eco-friendly than the existing processes which involve burning fossil fuels.

3. Placing Power Tiles at places such as roads, railroads, runways, and high foot-traffic areas will enable generating of useful amount of electrical power.

4. Power Tiles generate power without additional pollution, or with a minimum pollution if any.

5. Electrical power generated by Power Tiles may be used to power charging stations for electrical cars, hybrids, and any other cars or equipment that need electricity.

6. Power generated by Power Tiles may be a convenient source of power along roads in case of need for charging between the charging stations.
